(19) United States
(12) Patent Application Publication
(10) Pub. No.: US 2012/0142835 A1
(43) Pub. Date: Jun. 7, 2012

(54) THERMOPLASTIC RESIN COMPOSITION FOR CLEANING

(76) Inventor: Naoki Wakita, Hyogo (JP)

(21) Appl. No.: 13/390,237

(22) PCT Filed: Aug. 25, 2010
(86) PCT No.: PCT/JP2010/064325

§ 371 Date: Feb. 13, 2012

(30) Foreign Application Priority Data
Aug. 26, 2009 (JP) 2009-195681

(51) Int. Cl. C08K 5/42; C08L 33/02; C08L 33/12; C08L 51/06; C08L 37/00; C08L 23/12; C08L 53/00

(52) U.S. Cl. 524/158; 524/502; 524/528; 524/522; 524/505; 524/504; 524/517; 524/523; 524/166

(57) ABSTRACT

The present invention provides a thermoplastic resin composition for cleaning, containing: (A) 100 parts by mass of polypropylene resin, (B) 0 to 50 parts by mass of a thermoplastic resin which is not compatible with the polypropylene resin of the component (A), (C) 0.5 to 50 parts by mass of a thermoplastic resin for making the polypropylene resin of the component (A) compatible with the thermoplastic resin of the component (B), and (D) 0.5 to 15 parts by mass of a surfactant.

### TECHNICAL FIELD

The present invention relates to a thermoplastic resin composition for cleaning, which is used for cleaning the inside of a thermoplastic resin molding machine such as an extruder or an injection molding machine.

### BACKGROUND ARTS

JP-A 2009-107160 discloses a cleaning composition for molding machine which contains a thermoplastic resin, a second thermoplastic resin which is not compatible with the thermoplastic resin, and a fluorinated polymer, and JP-A 2005-219398 discloses a cleaning agent for molding machine which contains a styrene-based resin and a propylene-based resin. Both of them show significant phase separation of the two resins and do not give enough function as a cleaning agent.

JP-A05-42547 discloses a cleaning agent for molding machine in which a graft polymer composed of an olefin-based polymer and a styrene-based polymer is mixed with a styrene-based thermoplastic resin, and JP-A 08-155969 discloses a cleaning agent for molding machine in which a styrene-acrylonitrile-based resin, a polyethylene-based ultra high polymer, and a graft polymer composed of an olefin-based polymer and a styrene-based polymer are mixed. In these publications there is described an effect in which replacement is easy when a resin to be molded after using the cleaning agent is an olefin-based resin. However, replacement property to polypropylene resin and cleaning ability itself are not sufficiently satisfied.

In JP-A 03-207734 there is disclosed a resin composition for cleaning where a polyolefin-based resin, a polymethyl methacrylate, a neutral salt of an organic sulfonic acid, a basic magnesium carbonate, magnesium hydroxide, aluminum hydroxide, zinc carbonate or a mixture of two or more of these are mixed, but cleaning ability thereof is insufficient.

JP-A 10-279816 and JP-A 11-106667 disclose a thermoplastic resin composition for cleaning which contains the particular methyl methacrylate-styrene copolymer and the particular surfactant in a thermoplastic resin. JP-A 04-246443 discloses a resin composition for cleaning in which a mixture of a polyolefin-based resin, an acrylate-based copolymer, a neutral salt of an organic sulfonic acid, magnesium carbonate, magnesium hydroxide, and the like is mixed. All of these compositions do not have sufficient cleaning ability.

In JP-A 04-246443 there is disclosed a resin composition for cleaning which contains an acrylate-based copolymer, a salt of an organic sulfonic acid, an inorganic particle in a polyolefin-based resin, but cleaning ability thereof is not sufficient.

In JP-A 07-329113 there is disclosed a resin composition for cleaning a molding machine which contains an olefin-based resin modified with an unsaturated group-containing carboxylic acid derivative, a polyalkylene oxide surfactant or polyalkylene glycol surfactant, and a metal salt of a fatty acid in an olefin-based thermoplastic resin, but cleaning ability thereof is not sufficient.

### SUMMARY OF INVENTION

The problem to be solved by the present invention is to provide a thermoplastic resin composition for cleaning, which has good cleaning ability when used for cleaning the inside of a thermoplastic resin molding machine such as an extruder or an injection molding machine, and is easily replaced by polypropylene when polypropylene is subsequently molded after cleaning.

According to the present invention, there can be provided, as the means to solve the problem, a thermoplastic resin composition for cleaning, containing:

(A) 100 parts by mass of polypropylene resin,

(B) 0 to 50 parts by mass of a thermoplastic resin which is not compatible with the polypropylene resin of the component (A),

(C) 0.5 to 50 parts by mass of a thermoplastic resin for making the polypropylene resin of the component (A) compatible with the thermoplastic resin of the component (B), and

(D) 0.5 to 15 parts by mass of a surfactant.

According to the thermoplastic resin composition for cleaning of the present invention, cleaning ability is excellent when used for cleaning the inside of a thermoplastic resin molding machine such as an extruder or an injection molding machine, and replacement with polypropylene becomes easier when polypropylene is subsequently molded after cleaning.

### DETAILED DESCRIPTION OF THE INVENTION

<Component (A)>

The polypropylene resin of the component (A) may be a homopolymer or a block copolymer. Preferable block copolymer is a block copolymer of propylene and ethylene.

The polypropylene resin of the component (A) can be a mixture of homopolymer and block copolymer of polypropylene, and a mass ratio of the homopolymer to the block copolymer is preferably 1/9 to 9/1, more preferably 1/9 to 4/6.

<Component (B)>

The component (B) is the thermoplastic resin which is not compatible with the polypropylene resin of the component (A). Although the component (B) is not the essential component, it is a component which enhances cleaning ability when contained.

It is preferable that thermoplastic resin of the component (B) is one or more selected from polymers or copolymers which include at least one of methyl methacrylate and styrene. Examples of these polymers or copolymers can include one or more selected from an AS resin, an MS resin, a copolymer of methyl metacrylate-maleic acid anhydride-styrene, and a PMMA resin.

The content rate of the thermoplastic resin of the component (B) is, relative to 100 parts by mass of the component (A), 0 to 50 parts by mass, preferably 3 to 40 parts by mass, and more preferably 5 to 30 parts by mass.

<Component (C)>

The thermoplastic resin of the component (C) is a component for making the polypropylene resin of the component (A) compatible with the thermoplastic resin of the component (B). It should be noted that, when the component (B) is not contained, cleaning ability of the composition can be enhanced by adding the component (C), because the component (C) itself has a cleaning effect.

It is preferable that the thermoplastic resin of the component (C) is one or more selected from graft copolymers in which a polymer or a copolymer including at least one of a (meth)acrylic acid ester and styrene is grafted. Here, the (meth)acrylic acid ester indicates an acrylic acid ester or a methacrylic acid ester.

It is preferable that the graft copolymer is a graft copolymer which has an olefin-based resin as a main chain and in which a polymer or a copolymer including at least one of a (meth)acrylic acid ester and styrene is grafted. In such a case, the olefin-based resin as a main chain is preferably a PP resin, an LDPE resin, and an EEA resin, and the grafted polymer or copolymer is preferably an AS resin and a (meth)acrylic resin.

The content rate of the thermoplastic resin of the component (C) is, relative to 100 parts by mass of the component (A), 0.5 to 50 parts by mass, preferably 2 to 30 parts by mass, and more preferably 3 to 20 parts by mass.

<Component (D)>

Examples of the surfactant of the component (D) can include one or more selected from a metal salt of an alkane sulfonic acid, a metal salt of an α-olefin sulfonic acid, and a metal salt of an alkyl benzene sulfonic acid. Specifically there can be used those described in Paragraphs 0052 to 0058 of JP-A 2006-257297.

The content rate of the surfactant of the component (D) is, relative to 100 parts by mass of the component (A), 0.5 to 15 parts by mass, preferably 1 to 10 parts by mass, and more preferably 2 to 5 parts by mass.

<Component (E)>

The polyethylene resin of the component (E) is a component which enhances cleaning ability. It is possible to enhance cleaning ability more by combining the polyethylene resin of the component (E) with the copolymer of propylene and ethylene as the polypropylene resin of the component (A).

The content rate of the polyethylene resin of the component (E) is, relative to 100 parts by mass of the component (A), 1 to 30 parts by mass, preferably 3 to 25 parts by mass, and more preferably 5 to 20 parts by mass.

<Component (F) and Component (G)>

The ethylene-acrylic-based copolymer of the component (F) and the unsaturated carboxylic acid modified polyolefin resin of the component (G) are components which aid the improvement of cleaning ability by the component (B) and the component (C).

The ethylene-acrylic-based copolymer of the component (F) is a copolymer of ethylene and an alkyl ester of (meth)acrylic acid such as methyl (meth) acrylate or ethyl (meth) acrylate. Here, the (meth)acrylic acid means acrylic acid or methacrylic acid.

The content rate of the ethylene-acrylic-based copolymer of the component (F) is, relative to 100 parts by mass of the component (A), 3 to 30 parts by mass, preferably 5 to 20 parts by mass, and more preferably 5 to 15 parts by mass.

The unsaturated carboxylic acid modified polyolefin resin of the component (G) has a structure in which an unsaturated carboxylic acid such as maleic acid is bonded to polyethylene, polypropylene or the like.

The content rate of the unsaturated carboxylic acid modified polyolefin resin of the component (G) is, relative to 100 parts by mass of the component (A), 3 to 30 parts by mass, preferably 5 to 20 parts by mass, and more preferably 5 to 15 parts by mass.

<Other Components>

The composition of the present invention can further contain an inorganic filler. Examples of the inorganic filler can include, in addition to well known glass fiber and metal fiber, fillers selected from molten slag, steel slag or crushed products thereof, artificial mineral fiber described in JP-A2006-257297, and there can be used fillers in the form of fiber and non-fiber (powder, particles, crushed products, and the like).

The composition of the present invention can contain further an alkylene glycol fatty acid ester, an organic phosphorous compound, a polyalcohol, metal soap described in JP-A 2006-257297.

The composition according to the present invention is produced, for example, by previously mixing each of the aforementioned components through the use of a mixer such as Henschel mixer, tumbler blender or kneader, and then, by kneading through the use of an extruder or melt-kneading through the use of heated rolls or Banbury mixer.

The cleaning mechanism of improvement of the cleaning ability by using the composition according to the present invention is not known, and the cleaning ability is considered to be improved, because, relative to the polypropylene resin of the component (A) which does not have any polar group, by adding the resin of the component (B) which is not compatible with the polypropylene resin and has a polar group, and further blending the component (C) which is a compatible agent of the component (A) and the component (B), to thereby be stabilized, the same effect is obtained as the case where a polar group is substantially imparted to the polypropylene resin of the component (A). It should be noted that even when the component (B) is not contained, a high cleaning ability can be obtained by combining the respective components (A), (C) and (D).

Since the composition according to the present invention contains the polypropylene resin of the component (A) as a base component, the composition is easily replaced by a polypropylene resin after cleaning, and is suitable for cleaning the thermoplastic resin molding machine such as an extruder or an injection molding machine which is used for molding of polypropylene.

### EXAMPLES

In the followings, the present invention will be more specifically explained on the basis of Example, but is not limited to these Examples.

### Example and Comparative Example

The following cleaning test was performed by using the compositions (represented by parts by mass) shown in TABLE 1. The results are shown in TABLE 1.

<Cleaning Test>

An injection molding machine (“MITSUBISHI INJECTION MOLDER 265/100MSII” manufactured by MITSUBISHI HEAVY INDUSTRIES, LTD., cylinder temperature 250° C.) made use of a red colored product of polypropylene resin (Prime Polypro J-2000GP manufactured by Prime Polymer Co., Ltd., MFR 21) as a prior resin, to mold ten flat plates of 10 cm×10 cm, having a thickness of 2 mm.

Subsequently, by causing each of the compositions of TABLE 1 to flow until the red color disappeared (visually confirmed whether or not the red color turned to white), the cleaning evaluation of the use amount (kg) of the composition was performed. The smaller the use amount (kg) is, the better the cleaning ability is.

Furthermore, after that, by causing 1 kg of an AS resin to flow, it was observed whether or not a red-colored portion was adhered to the AS resin. When a red-colored portion is adhered to the AS resin, even if cleaning ability is apparently good (visually confirmed), the result shows that the cleaning is not sufficient practically.

<Replacement property>

When any red-colored portion was not observed after causing 1 kg of the AS resin to flow in the above cleaning test, the molding machine was again replaced sufficiently with the red colored product of polypropylene resin, and then ten flat plates of 10 cm×10 cm, having a thickness of 2 mm were molded. After that, each of the compositions of TABLE 1 was caused to flow until the red color disappeared (visually confirmed). Subsequently, a non-colored polypropylene resin (Prime Polypro J-2000GP manufactured by Prime Polymer Co., Ltd., MFR 21) was caused to flow, and the amount (kg) of the polypropylene resin used until the respective compositions previously caused to flow were not present in the polypropylene resin (until determined visually that the color of the molten resin discharged from the molding machine turned to transparent) was evaluated. The smaller the use amount of the polypropylene resin is, the better the replacement property with a subsequent molding polypropylene resin is.

TABLE 1

| | | EXAMPLES | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| (A) | PP1 | 100 | | 100 | 100 | | 50 | 100 | 100 | 100 | 50 | 100 | 100 | 50 |
| | PP2 | | 100 | | | 100 | 50 | | | | 50 | | | 50 |
| (B) | AS | 10 | 10 | | | | | 10 | 10 | 10 | | | | 10 |
| | MS | | | | | | | | | | | 10 | 10 | |
| (C) | PP-g-AS | 20 | 20 | 20 | 10 | 10 | 10 | 10 | | | 10 | 10 | 10 | 5 |
| | EEA-g-AS | | | | | | | | 10 | | | | | |
| | EEA-g-P | | | | | | | | | 10 | | | | |
| | (BM/MMA) | | | | | | | | | | | | | |
| (D) | Surfactant | 3 | 3 | 3 | 3 | 3 | 3 | 3 | 3 | 3 | 3 | 3 | 3 | 3 |
| (E) | PE | | | | 10 | 10 | 10 | 10 | 10 | 5 | 5 | 5 | 5 | 5 |
| (F) | EMMA | | | | | | | | | 10 | 10 | 10 | | 10 |
| (G) | MAH-PP | | | | | | | | | | | | 10 | 10 |
| Clean- | Amount of | 0.6 kg | 0.6 kg | 0.8 kg | 0.7 kg | 0.9 kg | 0.8 kg | 0.5 kg | 0.6 kg | 0.4 kg | 0.6 kg | 0.4 kg | 0.4 kg | 0.4 kg |
| ing | composition | | | | | | | | | | | | | |
| ability | (kg) | | | | | | | | | | | | | |
| | Adhesion of | Non | Non | Non | Non | Non | Non | Non | Non | Non | Non | Non | Non | Non |
| | color to | | | | | | | | | | | | | |
| | AS resin | | | | | | | | | | | | | |

| | | | | | | | | | | | | | |
|---|---|---|---|---|---|---|---|---|---|---|---|---|---|
| Replacement properly | 0.5 kg | 0.4 kg | 0.5 kg | 0.5 kg | 0.4 kg | 0.5 kg | 0.5 kg | 0.5 kg | 0.5 kg | 0.5 kg | 0.5 kg | 0.5 kg | 0.4 kg |

| | | COMPARATIVE EXAMPLES | | | | | | | | | | |
|---|---|---|---|---|---|---|---|---|---|---|---|---|
| | | 1 | 2 | 3 | 4 | 5 | 6 | 7 | 8 | 9 | 10 | 11 |
| (A) | PP1 | 100 | 50 | 100 | 80 | | 20 | 20 | 80 | | | 20 |
| | PP2 | | 50 | | 20 | 100 | 80 | 80 | 20 | | | |
| (B) | AS | | | | 20 | | | 10 | | 100 | 100 | 80 |
| | MS | | | | | 20 | | | | | | |
| (C) | PP-g-AS | | | 20 | | | | | 5 | | | |
| | EEA-g-AS | | | | | | | | | | | |
| | EEA-g-P | | | | | | | | | | | |
| | (BM/MMA) | | | | | | | | | | | |
| (D) | Surfactant | | 3 | | | 3 | 3 | 3 | | | 3 | 3 |
| (E) | PE | | | | | | | 5 | 5 | | | |
| (F) | EMMA | | | | | | 10 | | 10 | | | |
| (G) | MAH-PP | | | | | | | 10 | 10 | | | |
| Clean- | Amount of | >2 kg | >2 kg | 1.5 kg | 1.2 kg | 1.5 kg | 0.8 kg | 0.7 kg | 1.2 kg | 2 kg | 1.0 kg | 1.0 kg |
| ing | composition | | | | | | | | | | | |
| ability | (kg) | | | | | | | | | | | |
| | Adhesion of | Observed | Observed | Non | Observed | Observed | Observed | Observed | Observed | Non | Non | Non |
| | color to | | | | | | | | | | | |
| | AS resin | | | | | | | | | | | |

| | | | | | | | | | | | |
|---|---|---|---|---|---|---|---|---|---|---|---|
| Replacement property | — | — | 0.4 kg | — | — | — | — | — | >2 kg | >2 kg | >2 kg |

Component (A)
PP1 (Polypropylene): Prime Polypro E-150GK manufactured by Prime Polymer Co., Ltd. (block copolymer of ethylene-propylene, MFR 0.6)
PP2 (Polypropylene): Prime Polypro E-111G manufactured by Prime Polymer Co., Ltd. (homopolymer, MFR 0.5)
Component (B)
AS: AS resin, CEVIEN-N 080SF manufactured by Daicel Polymer Co.
MS: MS resin, CEVIEN-MAS MAS30 manufactured by Daicel Polymer Co.
Component (C)
PP-g-AS: Graft copolymer of PP as a main chain and AS as a side chain, MODIPER A3400 manufactured by NOF Corporation
EEA-g-AS: Graft copolymer of ethylene-ethyl acrylate copolymer as a main chain and AS as a side chain, MODIPER A5400 manufactured by NOF Corporation
EEA-g-P (BA/MMA): Graft copolymer of ethylene-ethyl acrylate copolymer as a main chain and butyl acrylate/methyl methacrylate copolymer as a side chain, MODIPER A5300 manufactured by NOF Corporation
Component (D)
Surfactant: Sodium dodecylbenzenesulfonate
Component (E)
PE (polyethylene): HIGHZEX 5000SF manufactured by Prime Polymer CO., Ltd. (high density PE, MFR 0.66)
Component (F)
EMMA (ethylene-methyl methacrylate copolymer): ACRYFT WD201 manufactured by SUMITOMO CHEMICAL
Component (G)
MAH-PP (maleic acid modified polypropylene): Modic P908 manufactured by MITSUBISHI CHEMICAL

1. A thermoplastic resin composition for cleaning comprising:
(A) 100 parts by mass of polypropylene resin,
(B) 0 to 50 parts by mass of a thermoplastic resin which is not compatible with the polypropylene resin of the component (A),
(C) 0.5 to 50 parts by mass of a thermoplastic resin for making the polypropylene resin of the component (A) compatible with the thermoplastic resin of the composition (B), and
(D) 0.5 to 15 parts by mass of a surfactant.

2. The thermoplastic resin composition for cleaning according to claim 1, wherein the content of the thermoplastic resin of the component (B) is 3 to 40 parts by mass.

3. The thermoplastic resin composition for cleaning according to claim 1, further comprising (E) 1 to 30 parts by mass of a polyethylene resin relative to 100 parts by mass of the polypropylene resin of the component (A).

4. The thermoplastic resin composition for cleaning according to claim 1, further comprising (F) 3 to 30 parts by mass of an ethylene-acrylic-based copolymer and/or (G) 3 to 30 parts by mass of an unsaturated carboxylic acid modified polyolefin resin relative to 100 parts by mass of the polypropylene resin of the component (A).

5. The thermoplastic resin composition for cleaning according to claim 1, wherein the polypropylene resin of the component (A) is a mixture of homopolymer and a block copolymer of polypropylene and a weight ratio of the homopolymer to the block copolymer is 1/9 to 9/1.

6. The thermoplastic resin composition for cleaning according to claim 1, wherein
the thermoplastic resin of the component (B) is one or more selected from the group consisting of polymers or copolymers including at least one of methyl methacrylate and styrene, and
the thermoplastic resin of the component (C) has an olefin-based resin as a main chain and is one or more selected from the group consisting of graft copolymers in which a polymer or a copolymer including at least one of a (meth)acrylic acid ester and styrene is grafted.

7. The thermoplastic resin composition for cleaning according to claim 1, wherein the thermoplastic resin of the component (B) is one or more selected from the group consisting of an AS resin, an MS resin, a copolymer of methyl methacrylate-maleic acid anhydride-styrene, and a PMMA resin.

8. The thermoplastic resin composition for cleaning according to claim 1, wherein
the thermoplastic resin of the component (C) is a graft copolymer which has an olefin-based resin as a main chain and in which a polymer or a copolymer including at least one of methyl methacrylate and styrene is grafted,
said olefin-based resin as a main chain is a PP resin, an LCPE resin or an EEA resin,
said grafted polymer or copolymer is an AS resin or a (meth)acrylic resin.

9. The thermoplastic resin composition for cleaning according to claim 1, wherein the surfactant of the component (D) is one or more selected from the group consisting of a metal salt of an alkane sulfonic acid, a metal salt of an α-olefin sulfonic acid, a metal salt of an alkyl benzene sulfonic acid.
